(19) United States
(12) Patent Application Publication
(10) Pub. No.: US 2004/0154168 A1
(43) Pub. Date: Aug. 12, 2004

(54) Dust and debris shield for powered hand tool

(76) Inventor: Jon Anthony McDonald, Woodland Hills, CA (US)

Correspondence Address: The Gilbert Law Building, 22130 Clarendon Street, Woodland Hills, CA, 91367, US

(21) Appl. No.: 10/360,837

(22) Filed: Feb. 7, 2003

(51) Int. Cl. B26B 1/00; B26B 3/00

(52) U.S. Cl. 30/124; 30/390

(57) ABSTRACT

A dust and debris shield for a power hand tool is disclosed. According to the invention, the invention includes a bifurcated dust and debris shield that is readily affixed to a wide variety of power hand tools utilizing material processing heads. The shield is comprised of two primary shield components including a material processing head encompassing portion to be affixed to the power hand tool about an axial housing of the power hand tool, and a complementary-shaped outer housing portion to be engaged and disengaged with the head encompassing portion, the outer housing portion further including an exhaust tube for coupling to a suction or vacuum hose. According to one embodiment, the outer housing portion is engaged with the head encompassing portion in a nesting engagement achieved with a sliding fit therebetween, and the head encompassing portion is removably secured to the power hand tool with a generally circular clamping arrangement about the power output shaft housing through which the driving power shaft extends for securing the material processor head.

### CROSS-REFERENCE TO RELATED APPLICATIONS

not applicable

### STATEMENT RE: FEDERALLY SPONSORED RESEARCH/DEVELOPMENT:

not applicable

### BACKGROUND OF THE INVENTION

1. Field of the Invention

The present invention relates to power hand tools, and more particularly, to an improved dust collecting shield for power hand tools for collecting dust and debris generated by a material processing action in the area adjacent to the material processing head.

2. Description of the Related Art

Material processing equipment, specifically hand-held power tools, are well known and widely used in a wide variety of industries and applications. Such hand-held power tools include saws, grinders, routers, polishers, and the like. Inherent to their operation, these tools typically employ rotating cutting members, such as circular cutting blades, grinding wheels, router bits, and polishing heads, each of which typically are driven at high rotational speeds during, before and after a material processing operation is performed. As is well known, the use of such material processing blades, wheels, bits and heads generate substantial amount of loose particulate matter, which potentially poses environmental and personal threats. Specifically, during such material processing operations, particulate matter is expelled at high velocity into the surrounding environment, potentially presenting a substantial hazard to the operator and causing the contamination of tools and other articles that may located adjacent to the work area.

For many such hand-held power tools, at best only a rudimentary dust shield is provided adjacent to the exit path of the particulate matter generated and/or expelled during material processing, and such dust shields are commonly regarded as being ineffective in collecting or containing such undesirable dust and debris dispersal. Furthermore, such rudimentary dust shields are typically not provided with means for use with a suction-based dust evacuation system as is more commonly found in commercial and industrial work environments. Accordingly, those prior art dust shields have satisfactorily overcome the so-described structural or performance problems and limitations, at best providing notably cumbersome attachments, an unacceptable requirement to perform significant disassembly of the power tool to install or disassemble a retrofitted dust shield apparatus, or means for being readily attached to a suction-based dust evacuation system. Thus, it will be appreciated that there is a strong disincentive to utilize those prior art apparatus in view of the widely-acknowledged shortcomings of the prior art.

Accordingly, there is a need for an effective dust and debris shield for receiving and channeling flying dust and debris generated by a power hand tool, and especially one that is readily fitted or retrofittable to any of a wide variety of power hand tools known to generate significant dust and debris, in a manner that satisfactorily overcomes the significant prior art problems noted above. Specifically, there is a need for a dust and debris shield that is readily installed yet in the installed condition allows the operator to readily access the material processor head for cleaning, repair and replacement purposes, and which is readily secured to a vacuum suction apparatus.

### OBJECTS AND SUMMARY OF THE INVENTION

Accordingly, it is an object of the present invention to provide an improved dust and debris shield apparatus for use with a hand-held power tool.

It is another object of the present invention to provide an improved dust and debris shield apparatus that is readily installed and removed, and which provides for ready access to the material processor head for cleaning, repair and replacement purposes.

It is a further object of the present invention to provide an improved dust and debris shield apparatus that is readily secured to a vacuum suction apparatus.

These and other objects are achieved, according to the present invention, by use of a bifurcated dust and debris shield that is readily affixed to a wide variety of power hand tools and especially those having material processing heads including saws, grinders, routers, polishers, and the like. According to the invention, the dust and debris shield is comprised of two primary shield components, those components including an inner shield portion for partially encompassing an arc of the plane of rotation of the rotating processing head radially to be affixed to the power hand tool about an axial housing of the power hand tool, and a complementary-shaped outer shield portion to be simply and readily engaged and disengaged with the inner shield portion, the outer shield portion further optionally including an exhaust tube for coupling to a suction or vacuum hose. Specifically, the outer shield portion is readily engaged with the inner shield portion in a nesting engagement achieved with a sliding fit therebetween, and the inner shield portion is removably secured to the power hand tool with a generally circular clamping arrangement collinear with the power output shaft housing through which the driving power shaft extends for securing the material processor head thereto.

The above objects and description together with other objects and description of the invention, along with the various features of novelty which characterize the invention, are pointed out with particularity in the claims annexed to and forming a part of this disclosure. For a more complete understanding of the present invention, its performance, structural and operating advantages and the specific objects attained by its uses, reference shall be made to the accompanying drawings and description in which there are presented exemplary preferred embodiments of the invention.

### BRIEF DESCRIPTION OF THE DRAWINGS

FIG. 1 is a top plan view of a hand held power hand tool to which the dust and debris shield of the present invention is installed, showing the material processing head encompassing portion, and affixed thereto the outer housing portion in the fully assembled condition, including an optional exhaust tube for coupling to a suction or vacuum hose in-line with a vacuum pump, according to one embodiment of the present invention.

FIG. 2 is a perspective, exploded view of the dust and debris shield of the present invention, showing its application according to one embodiment to a hand held power rotary sander or grinder.

FIG. 3 is a cross-sectional view taken along line 3-3 of FIG. 2, further showing the engagement of the material processing head encompassing portion in a generally circular clamping arrangement about the power output shaft housing through which the driving power shaft extends for securing the material processor head, and the outer housing portion engaged with the head encompassing portion in a nesting engagement achieved with a sliding fit therebetween.

FIG. 4 is a top plan exploded view of the two primary shield components, and the intended assembly and disassembly mechanism to engage and disengage the outer housing portion engaged with the head encompassing portion in a nesting engagement as shown in FIG. 3.

### DETAILED DESCRIPTION OF THE PREFERRED EMBODIMENTS

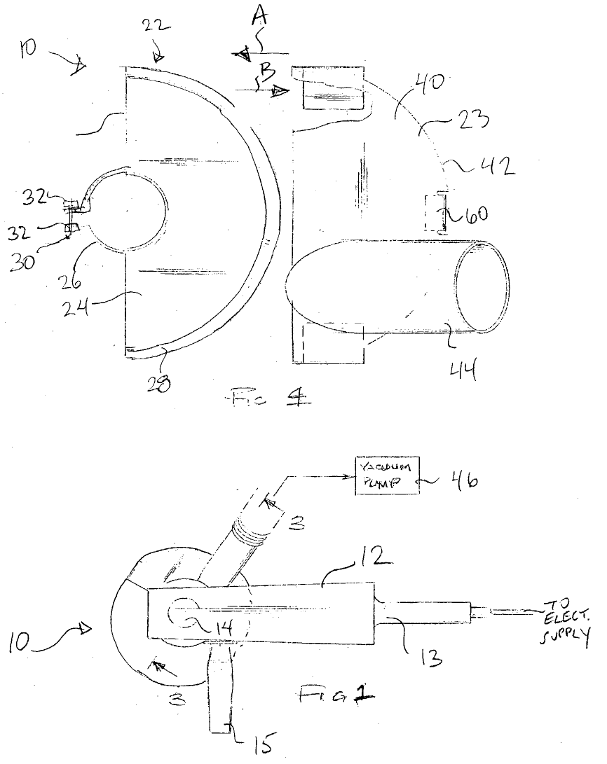

Referring now to the drawings wherein like numerals designate like and corresponding parts throughout the several views, FIGS. 1-4 show the dust and debris shield 10 of the present invention, for use with hand held power tools in the manner to be more fully described below. According to the invention, dust and debris shield 10 is configured for use with a hand-held power tool 12, having main body 13 and auxiliary handle 15, which may be selected from the group including but not limited to rotary saws, grinders, routers, polishers, and the like, all of which employ a power supply typically being an electric motor 14 driving a power output shaft 16 extending through a housing 18 and supporting at a distal end thereof a rotatable material processor head 20. Such rotatable head 20 is a rotating cutting member, such as a circular cutting blade, grinding wheel, sanding head, router bit, or polishing head, each of which may be driven at high rotational speeds during, before and after a material processing operation is performed, thereby generating a substantial amount of loose particulate matter flung off primarily in a tangential direction. The power output shaft 16 runs through a shaft housing 19 coextensive with housing 18.

In order to capture particulate matter generated by operation of power tool 12 against a workpiece, dust and debris shield 10 includes an inner shield portion 22 having a generally semi-circular flange member 24 extending orthogonally from and supported by a circular clamp 26, flange member 24 extending substantially parallel to a face of rotatable material processor head 20 in the installed condition as will be more fully described below. Flange member 24 extends radially outwardly and transitions at its circumferential outer extent to a curvilinear channel 28 configured to closely parallel and bracket the outer running surface of rotatable material processor head 20 to capture generated particulate matter. Clamp 26 is configured to be removably secured about shaft housing 19 using any suitable bolted or clamped securing apparatus, such as the bolted connection 30 projecting through a pair of opposing clamp tabs 32 shown in FIGS. 2 and 4, although it will be understood that other securing devices such as quick-release clamps or other securing devices may be used without departing from the spirit and scope of the present invention. It will be further appreciated that such ready securement means enables the head 20 to be readily installed and removed from the power tool 12, and which provides for ready access to the material processor head 20 for cleaning, repair and replacement purposes.

According to one preferred embodiment, flange member 24 of inner shield portion 22 is configured with a semi-circular planar structure. It will be apparent to the skilled artisan, however, that flange member 24 may be provided with a greater or lesser extension arc (i.e. greater or less than an arc of 180 degrees) to provide a greater or lesser extent of planar coverage of the face of the material processor head 20, with an attendant greater or lesser extent of curvilinear channel 28. According to one preferred embodiment, inner shield portion 22 is fabricated from sheet steel or other durable metallic or polymeric material that may be readily configured into the structural shapes so described, further in view of weight and cost considerations.

Again with reference to the drawing figures, the dust and debris shield 10 also includes outer shield portion 23 to be engaged and disengaged with the inner shield portion 22 in the manner to be more fully described below. More particularly, outer shield portion 23 includes a flanged side wall 40 having an overall size and shape generally complementary to the flange member 24 of inner shield portion 22, further extending to an engaging channel 42 shaped generally complementary to curvilinear channel 28. An exhaust tube 44 extends from side wall 40 for evacuation of particulate matter therethrough under power of vacuum pump 46. According to one preferred embodiment, outer shield portion 23 is fabricated from sheet steel or other durable metallic or polymeric material that may be readily configured into the structural shapes so described, further in view of weight and cost considerations. It will be appreciated that inner shield portion 22 may be fabricated of a material the same or different from that of outer shield portion 23, and such consideration will take into account the anticipated service application and severity, as well as cost, weight and marketing considerations.

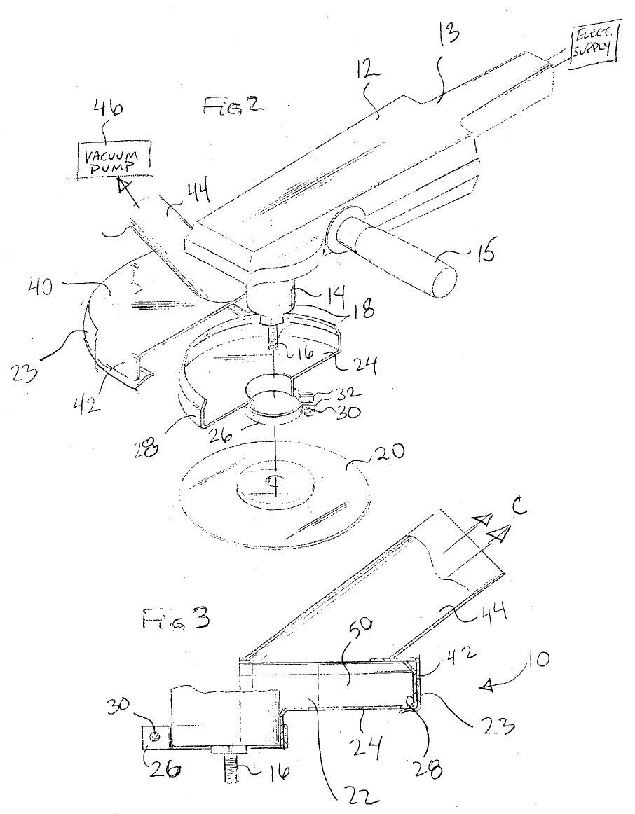

In application, inner shield portion 22 is secured to the power tool 12 by securing circular clamp 26 at a longitudinal extent of shaft housing 19 such that the plane of rotation of processor head 20 is substantially centered with respect to the curvilinear channel 28 of inner shield portion 22. Outer shield portion 23 is slidably engaged with inner shield portion 22 in the direction of arrow A (FIG. 4) such that engaging channel 42 circumferentially brackets curvilinear channel 28 in overlapping fashion, with flange member 24 and flanged sidewall 40 on opposite sides of the engaged channels 28, 42 to define a concavity 50 (FIG. 3) into which dust and debris are collected and then channeled into exhaust tube 44 for disposal under pressure of vacuum pump 46 in the direction of arrows B. Disassembly of the so engaged apparatus merely requires reversal of the above-described procedure to accomplish separation of inner shield portion 22 from outer shield portion 23 in the direction of arrow B (FIG. 4).

Optionally, an L-shaped clip 60 (FIG. 4) may be provided or integrally formed with the periphery of outer housing portion 23 to further secure the assembly of the inner and outer shield portions 22, 23 during use, transport, or storage. Specifically, when inner shield portion 22 and outer shield portion 23 are assembled in the manner described, tension clip 60 is urged against the outer face of flange member 24 to maintain the assembly of inner and outer shield portions 22, 23 in tension to further secure the assembly against release due to shock and vibration generated by the power hand tool, vibration generated during material processing, or inadvertent impacts against outer shield portion 23 that would otherwise cause it to become partially or fully dislodged from a full engagement with inner shield portion 22.

It is to be understood that the present invention is not limited to the embodiments described above, but encompasses any and all embodiments within the scope of the following claims.

What I claim is:

1. A dust and debris shield for a tool having a rotatable material processing head, the shield comprising:
an inner shield portion removably secured to the tool, the inner shield portion supporting a curvilinear channel encompassing an arc of the plane of rotation of the processing head radially outwardly of the processing head without contact therewith; and
an outer shield portion cooperatively engaged with the inner shield portion to define a volume to contain dust and debris generated by operation of the material processing head.

2. The dust and debris shield as recited in claim 1, further comprising an evacuation tube extending from the outer shield portion, the tube contiguous with the volume.

3. The dust and debris shield as recited in claim 1, further comprising a pressure source operatively engagable with the evacuation tube.

4. The dust and debris shield as recited in claim 1, further comprising a wall extending inwardly from the curvilinear channel of the inner shield.

5. The dust and debris shield as recited in claim 1, wherein the outer shield portion includes a wall extending to an engaging channel.

6. The dust and debris shield as recited in claim 5, wherein the engaging channel engages the curvilinear channel in overlapping relationship.

7. The dust and debris shield as recited in claim 1, wherein the arc is selected from the range of about 150 degrees to about 210 degrees.

8. The dust and debris shield as recited in claim 7, wherein the arc is about 180 degrees.

9. A dust and debris shield for a tool having a shaft-mounted rotatable material processing head driven by a power source, the shield comprising:
an inner shield portion removably secured to the tool, the inner shield portion having a wall supporting a curvilinear channel encompassing an arc of the plane of rotation of the processing head radially outwardly of the processing head without contact therewith; and
an outer shield portion having a wall supporting an engaging channel cooperatively engaged with the inner shield portion to define a volume to contain and redirect dust and debris generated by operation of the material processing head to an evacuation tube.

10. The dust and debris shield as recited in claim 9, wherein the engaging channel substantially overlaps the curvilinear channel in the fully assembled condition.

11. The dust and debris shield as recited in claim 9, further comp rising an evacuation tube extending from the outer shield portion, the tube contiguous with the volume.

12. The dust and debris shield as recited in claim 9, further comprising a pressure source operatively engaged with the evacuation tube.

13. The dust and debris shield as recited in claim 9, wherein the inner shield portion is removably affixed to a shaft housing.

14. The dust and debris shield as recited in claim 9, further comprising a pressure clip secured to the outer shield portion for engaging the inner shield portion in tension.

15. The dust and debris shield as recited in claim 9, wherein the inner shield portion and the outer shield portion are each fabricated from a metallic or polymeric material.

16. The dust and debris shield as recited in claim 9, wherein the shaft is driven by an electric motor.

17. A powered hand tool having a shaft-driven material processing head and a dust and debris shield, in combination: the shield including an inner shield portion removably secured to a drive shaft housing of the powered hand tool, the inner shield portion supporting a curvilinear channel encompassing an arc of the plane of rotation of the processing head radially outwardly of the processing head without contact therewith; and an outer shield portion cooperatively engaged with the inner shield portion to define a volume to contain dust and debris generated by operation of the material processing head.

18. The powered hand tool as recited in claim 17, wherein the inner shield portion is slidably engagable with the outer shield portion.

19. The powered hand tool as recited in claim 17, further comprising an evacuation tube extending from the outer shield portion, the tube contiguous with the volume.

20. The powered hand tool as recited in claim 18, further comprising a pressure source operatively engagable with the evacuation tube.
